(19) United States
(12) Patent Application Publication
(10) Pub. No.: US 2007/0239693 A1
(43) Pub. Date: Oct. 11, 2007

(54) DEVICE, METHOD AND COMPUTER PROGRAM FOR PROCESSING A SEARCH REQUEST

(76) Inventors: Oliver Hellmuth, Erlangen (DE); Bernhard Grill, Lauf (DE)

Correspondence Address: GLENN PATENT GROUP, 3475 EDISON WAY, SUITE L, MENLO PARK, CA, 94025, US

(21) Appl. No.: 11/697,210

(22) Filed: Apr. 5, 2007

Related U.S. Application Data
(60) Provisional application No. 60/744,323, filed on Apr. 5, 2006.

(51) Int. Cl. G06F 17/30

(52) U.S. Cl. 707/3

(57) ABSTRACT

A device for processing a search request includes a request receiver for receiving a search request from a first user and a categorizer for associating the search request with a category from a plurality of various categories. The device further includes a communication partner determiner for finding a second user that has made a search request associated with the same category and an information supplier for supplying information to the first user that the second user having made a search request of the same category exists, and information to the second user that the first user having made a search request of the same category exists. The above concept may also be implemented as a method and a computer program. The described concept allows users making search requests of the same category to enter into direct electronic communication. Thus, a particularly efficient knowledge exchange between various users of the inventive device is guaranteed.

### CROSS-REFERENCE TO RELATED APPLICATION

This application claims the benefit of U.S. Provisional Patent Application No. 60/744,323, filed on Apr. 5, 2006, and is incorporated herein by reference in its entirety.

### BACKGROUND OF THE INVENTION

1. Field of the Invention

The present invention generally relates to a device, a method and a computer program for processing a search request, particularly to linking the context of search requests of various users of a search engine to allow knowledge exchange via a communication platform.

2. Description of the Related Art

In today's information society, an ever-increasing amount of knowledge is created so that a single person can only take up a very small percentage of the total available knowledge. However, it is often necessary for the individual person to acquire new knowledge from the total amount of the available knowledge based on a specific question. For this purpose, the individual person has to have target-oriented access to the total available knowledge.

Up to now, it has been known to bring together a large amount of knowledge in an electronic database and to allow access to this knowledge to the user via a search function.

For example, in order to allow finding information from the World Wide Web and/or internet, there is a classic search engine technology, such as it is used in known search engines like “google” and “yahoo”. According to the classic search engine technology, after a search request, the user is presented with an ordered list with websites (and/or is presented with an ordered list with websites (and/or references to websites and/or URL addresses), based on certain algorithms, which have a predetermined relationship to the search terms as defined by the algorithm. The order of the list is also controlled by a given algorithm with the aim to place websites supposedly relevant for the search request at the top of the list. In practice, this sorting is frequently not always useful for the user and/or not really suitable for his/her search request. Sometimes, there is further an additional disturbance by advertising placed at the top of the list deliberately by technical measures. Thus, the user sometimes has considerable problems to obtain an appropriate response to his/her search request.

### SUMMARY OF THE INVENTION

It is the object of the present invention to provide a concept for processing a search request allowing a more efficient access to the available knowledge.

In accordance with a first aspect, the present invention provides a device for processing a search request, having a query receiver for receiving a search request from a first user; a categorizer for associating the search request with a category of a plurality of various categories; a communication partner determiner for finding a second user that has made a search request associated with the same category; and an information supplier for supplying information to the first user that the second user having made a search request of the same category exists, or for supplying information to the second user that the first user having made a search request of the same category exists.

In accordance with a second aspect, the present invention provides a method for processing a search request, having the steps of receiving a search request from a first user; associating the search request with a category from a plurality of various categories; finding a second user that has made a search request associated with the same category; and providing information to the first user that the second user having made a search request of the same category exists, or providing information to the second user that the first user having made a search request of the same category exists.

In accordance with a third aspect, the present invention provides a computer program with a program code for performing the above method, when the computer program runs on a computer.

The present invention provides a device for processing a search request having a request receiver for receiving a search request from a first user, a categorizer for associating the search request with a category from a plurality of various categories, and a communication partner determiner for finding a second user that has made a search request associated with the same category as the search request of the first user. The inventive device further includes an information supplier for supplying information to the first user that the second user having made a search request of the same category exists, or for supplying information to the second user that the first user having made a search request of the same category exists.

It is the core idea of an embodiment of the present invention that a particularly efficient use of a total available knowledge is possible by informing a user of a device for processing a search request when another user makes a search request of the same category. By providing the information that the second user has made and/or directed a search request of the same category to the device, for example to the first user of the inventive device, it thus becomes possible for the first user to deliberately establish direct contact with another user (i.e. the second user) whose search request concerns the same category (for example the same topic). Thus, users interested in the same category are informed about each other and/or, for example, brought together for setting up electronic communication.

An embodiment of the inventive device for processing a search request thus offers the advantage that knowledge may be accessed in a particularly efficient way by identifying users that potentially have knowledge in a certain category, instead of merely querying a knowledge database, and by giving these users the possibility to enter into direct communication with each other.

Thus, not only is there knowledge stored in machine and/or electronic form available to the users of the inventive device, but there is also the possibility to acquire knowledge of other users interested in the same category (for example the same topic).

Thus, the inventive device according to an embodiment allows communication between human users having made search requests of the same category. It has been found that a human communication partner that has already made a search request of the same category often understands a search request of another user better and may thus answer it faster than it is the case in a classic search engine inquiry.

Thus, a tedious search, for example in the internet and/or World Wide Web, may be eliminated under certain circumstances, thus saving both time and other resources (computing power and transmission power).

In a preferred embodiment, the information supplier is designed to supply information to the first user or the second user including a notification about a possibility to establish electronic communication with each other (between the first user and the second user) in response to detecting that the first user and the second user have made search requests associated with the same category. In other words, if two users of the inventive device are detected to have made search requests concerning the same category (and/or the same topic), at least one of the two users is informed how he/she may enter into electronic communication with the other user.

For example, one of the two users is provided with an electronic address and/or communication address of the other user or an anonymized user identification of the other user, or a communication possibility is established by the device itself so that the first user may enter into communication with the other user, for example directly or by following a link. In other words, providing information on a possibility to establish electronic communication with each other may, for example, include providing a communication possibility including an indication that communication with the other user is possible with the given communication possibility, or also merely providing electronic address information at which the other user may be reached.

Furthermore, it is preferred that the information provided by the information supplier includes a reference and/or information on the fact that the other user has made a search request of the same category to the device and/or that the other user potentially has competence regarding the search request.

In a further preferred embodiment, the inventive device is further designed to provide a communication platform via which the first user and the second user may communicate with each other. In this case, the information supplier is preferably designed to supply a message to the first user and the second user designed to allow access to the communication platform. In other words, the possibility of a communication between the first user and the second user is created by the device itself, and there is no necessity to establish an external path of an electronic communication between the first user and the second user. The communication platform is under the control of the inventive device, and the inventive device is, for example, capable of setting up the communication platform and assigning corresponding access identifications to the first user and the second user based on the search requests. The access identifications may be generated in response to the search request, so that there is a coordination between the communication platform and the device for processing the search request and/or the communication partner determiner. Thus, only by a search request, a user is already assigned to a suitable communication platform corresponding to the category of the search request. If there is no communication platform for the given category of the search request yet, it may, for example, be generated dynamically without requiring further action of the users. Thus, the users are spared the necessity, for example, to effect the setup of a communication platform in a separate step, when they are interested in a certain category of questions and/or search requests. A communication platform is established only based on the fact that two users make search requests of a matching category without even one of the users setting up a communication platform by himself or requesting the setup of a communication platform.

Furthermore, it is preferred that the information supplier supplies a message to the first user and/or the second user informing the first user of the existence of the second user or informing the second user of the existence of the first user, in addition to setting up the communication platform. In other words, in addition to merely setting up and/or providing a communication platform, at least one of the users, but preferably both users, are informed that there is another user that has made a search request of the same category and is therefore possibly available for communication via the communication platform.

In a further preferred embodiment, the inventive device is designed to provide an electronic chat room (and/or discussion room), via which the first user and the second user may communicate with each other, for example in response to the detection that the first user and the second user have made search requests of the same category. In this case, the information supplier is preferably designed to supply messages to the first user and the second user that contain a reference to the electronic chat room. However, one or both of the users may also be directed directly to the electronic chat room, and/or the electronic chat room may, for example, be part of a presented information reproduction page (for example website) or part of a framework on/in which there are also presented further results of the search request. Such a procedure is particularly advantageous, because an electronic chat room allows a topic-related and anonymous communication of two users within the same user interface (for example web browser), in which also the search request has been sent and/or in which other results regarding the search request are presented.

In a further preferred embodiment, the information supplier is designed to supply an authorization identifier to the first user and the second user authorizing the first user and the second user for an access to the electronic chat room. By the integration of the communication platform into the device for processing the search requests, it is, for example, possible to ensure that only persons that have actually made a search request concerning the particular category obtain access to the chat room. This guarantees optimal user guidance, because a user is directed exactly into the chat room corresponding to the search request. Access to other chat rooms that seem to be possibly interesting for a user, but do not correspond to his/her search request, may actually be suppressed. This results, for example, in increased search efficiency, resulting in a significant increase in effectiveness especially in a commercial environment. Besides, a user only obtains access to a communication platform, such as a chat room, if he/she makes a search request matching the level of the respective chat room. This, for example, prevents a user that makes a very general search request from entering a chat room in which (according to the corresponding category) a very special topic is discussed, wherein the user with the very general search request would not be able, for example, to follow the discussion of the very special topic and would possibly either disturb the discussion in the communication platform or disappointedly leave the communication platform.

Furthermore, linking the authorization for the communication platform with the submission of a search request may, for example, avoid excessive information amounts in the communication platform, because users typically first check some of the electronically generated results of the device for processing a search request and only use the communication platform if the automatically and/or electronically generated results of the search request do not answer their search request adequately. The mentioned mechanism to link a search request with the provision of a communication platform thus again guarantees a particularly high efficiency when processing the search requests.

In a further preferred embodiment, the information supplier is designed to supply information on an electronic communication address of the second user to the first user, or to supply information on an electronic communication address of the first user to the second user. The electronic communication address may, for example, be an email address, an IP address, an identifier for a chat room, a telephone number, an IP telephone number or an anonymized communication address (for example associated with the inventive device and allowing forwarding by the inventive device). The information on the electronic communication address of the other user preferably includes an indication that the other user has made a search request of the same category, i.e. for example concerning the same topic. By this measure, the first user is thus informed of the existence of the second user and/or the second user is informed of the existence of the first user, and at the same time a direct establishment of communication between the first user and the second user is made possible. The communication via the communication address then does not necessarily require any resources of the inventive device, but may be done via external devices and/or other service providers.

In another preferred embodiment, the inventive device includes a message forwarder and an identification database. The identification database is designed to store an association between anonymized electronic communication addresses and actual electronic communication addresses. The identification database includes, for example, an anonymized electronic communication address of the first user, an anonymized electronic communication address of the second user, an actual electronic communication address of the first user and an actual electronic communication address of the second user. The message forwarder is designed to receive an electronic message with an anonymized electronic communication address as target address, to read out an actual electronic communication address associated with the anonymized electronic communication address from the identification database, and to forward the electronic message with the read-out actual electronic communication address. In this case, the information supplier is preferably designed to supply the anonymized electronic communication address of the second user to the first user, or to supply the anonymized electronic communication address of the first user to the second user. Using the mentioned concept, the first user and the second user may communicate with each other in an anonymous way, wherein the communication messages per se may be generated and transmitted externally to the inventive device, and wherein the inventive device only performs forwarding the communication messages and replacing the anonymized communication address by an actual communication address stored in the identification database of the inventive device. The inventive device thus only takes the steps required for an anonymization, but does not have to bear the burden of the process of the communication between the first user and the second user apart from the forwarding.

In a further preferred embodiment, the communication partner determiner is designed to determine whether the second user is available for communication. In this case, the information supplier is preferably designed to supply the information only when the communication partner determiner indicates that the second user is available for communication. This avoids making the attempt to initiate a communication between two users, one of whom is not or not any more available for communication. This prevents disappointment of the remaining user and thus increases user satisfaction as a whole.

In a preferred embodiment, the communication partner determiner is designed to indicate that the second user is available for communication, when the second user has made a search request within a predetermined time interval (for example relative to the time of checking whether the second user is available). Observing the search requests of the second user may allow the inventive device for processing a search request to detect in a simple way whether the second user is active.

In a further preferred embodiment, the communication partner determiner is designed to find out whether the request receiver has received the search requests of the first user and the second user concerning the same category within a predetermined time interval. In this case, the information supplier is designed to supply the information only when the request receiver has received the search requests of the first user and the second user associated with the same category within the predetermined time interval. Such a procedure results in particularly high user satisfaction, because it may be assumed that a user is interested in a search request of a certain category only for a certain time interval.

If the search requests of the first user and the second user concern the same category, but the search requests are spaced apart in time too much (longer than the predetermined time interval), at least in some cases it is not useful to inform the two users of each other by the information supplier.

In a further embodiment, the inventive device includes an information database having a plurality of entries related to various possible search requests of various categories. In this case, an inventive device preferably includes an information database interrogator designed to search the information database for entries related to a search request of the first user. The information supplier is further preferably designed to provide information based on at least one entry of the information database related to the search request of the first user to the first user, in addition to the information that the second user having made the search request of the same category exists. In the mentioned embodiment, the result is a particularly advantageous linking of knowledge stored in the information database with knowledge of other users. Thus, both the knowledge from the information database is available to the first user and he/she may acquire the knowledge of the second user. Users may decide which way of information access and/or knowledge access they regard useful in view of the entries provided by the information database. In other words, with only one search request, the first user obtains both a reference to the knowledge collected in the information database and a reference to a human knowledge carrier, such as the second user, that has made a search request of the same category.

Furthermore, the inventive device may include a priority mechanism designed to set an order of access to the entries of the information database and the information regarding the second user that has made the search request of the same category for the first user. For example, the process control may be designed to display entries of the information database and/or the corresponding references to other information carriers only when the first user has gained knowledge of the existence of the second user, and, for example (but not necessarily), has either entered into communication with him/her, an attempt of a communication between the first user and the second user has failed, or the first user has informed the inventive device that he/she does not want to establish communication with the second user.

Alternatively, the information supplier may further be designed to first provide, for example, an amount of results of the information database query to the first user, and to provide the information on the existence of the second user to the first user only when the first user has seen the results of the information database query. This may be done, for example, by placing the results of the information database query in front of the information on the existence of the second user. Alternatively, the information supplier may also detect when the first user has consulted a plurality of information of the results of the information database query without success. Corresponding information may, for example, be acquired by evaluating the behavior of the first user or by receiving an explicit message of the first user.

In a further preferred embodiment, the categorizer is designed to associate the search request with at least one category based on one or more words occurring in the search request. In other words, the categorizer may be designed to analyze the search request, to divide it into words, and to determine the category of the search request based on the identified words from a database containing an association between words or word combinations and categories. Thus, the user is spared the burden to have to explicitly state the category of his/her search request. The category of the search request is rather generated automatically, for example by a database query.

In a further preferred embodiment, the categorizer is designed to output a list of categories with which the search request (for example according to the database query) may be associated for a user to read in a decision from the user with which category from the list of categories the search request is to be associated, and to associate the search request with a category based on the decision. Such an embodiment guarantees that the user may decide to which category the search request belongs, if the categorizer is not able to perform such an association in an unambiguous way. By a database query, the categorizer preferably creates a list of categories with which the search request may be associated to take the burden off the user. In this case, the user only has to make a final selection and/or a selection of the category from the list. It has been found that, in some cases, it is optimal to make a preselection of categories automatically and/or based on a database query and to leave a final decision to a user.

The present invention further provides a method for processing a search request parallel to the inventive device for processing a search request. The corresponding method includes receiving a search request of a first user, associating the search request with a category from a plurality of various categories, finding a second user that has made a search request associated with the same category, and supplying information to the first user that the second user having made a search request of the same category exists, or supplying information to the second user that the first user having made a search request of the same category exists.

The inventive method has the same advantages as the inventive device and may, in preferred embodiments, be supplemented by the same steps that also occur in the embodiments of the inventive device.

The present invention further includes a computer program for performing the inventive method.

### BRIEF DESCRIPTION OF THE DRAWINGS

Preferred embodiments of the present invention will be explained in more detail below with respect to the accompanying drawings, in which:

FIG. 1 shows a block circuit diagram of an inventive device for processing a search request according to a first embodiment of the present invention,

FIG. 2 shows a block circuit diagram of an inventive categorizer for the use in an inventive device according to FIG. 1;

FIG. 3 shows a schematic representation of a formation of common knowledge clusters by an analysis of search requests;

FIG. 4 shows a block circuit diagram of an inventive device for processing a search request according to a second embodiment of the present invention;

FIG. 5 shows a schematic representation of an invitation (E) of chat participants from a field of knowledge and of a knowledge transfer (WT) of all participants via a communication platform; and

FIG. 6 shows a flow diagram of an inventive method according to an embodiment of the present invention.

### DESCRIPTION OF THE PREFERRED EMBODIMENTS

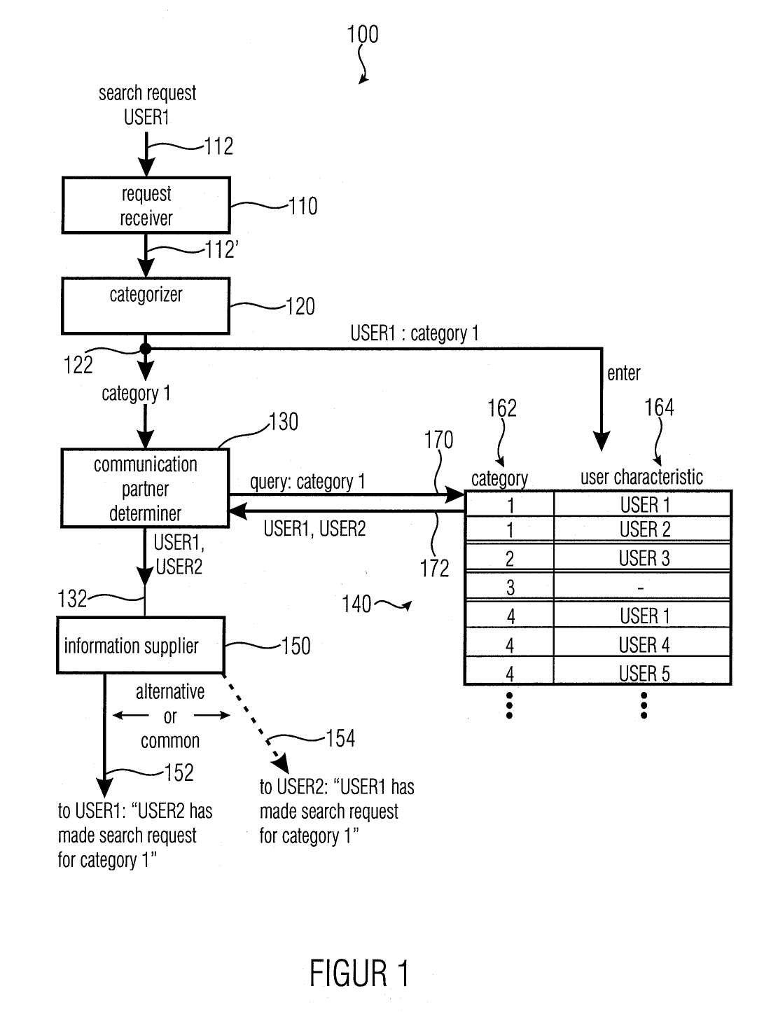

FIG. 1 shows a block circuit diagram of an inventive device for processing a search request. The device according to FIG. 1 is designated 100 in its entirety. The device 100 includes a query receiver 110 designed to receive a search query 112 from a first user. The first user is also designated USER 1 throughout the description. The search request 112 may, for example, consist of one word or several words. Alternatively or additionally, the user query may also include multimedia information, such as sounds, sound sequences, audio signals, video signals, image sections, images and other multimedia elements in any combination. The query receiver 110 then forwards the received search requests 112′ to a categorizer 120. The categorizer 120 is designed to associate the search request 112 or the received search request 112′ with a category (for example category 1) from a plurality of various categories. The categorizer 120 may further alternatively be designed to associate the search request 112, 112′ with several categories. If the search request 112, 112′ further does not correspond to any of the categories known to the categorizer 120, the categorizer 120 may generate a new category corresponding to the search request 112, 112′.

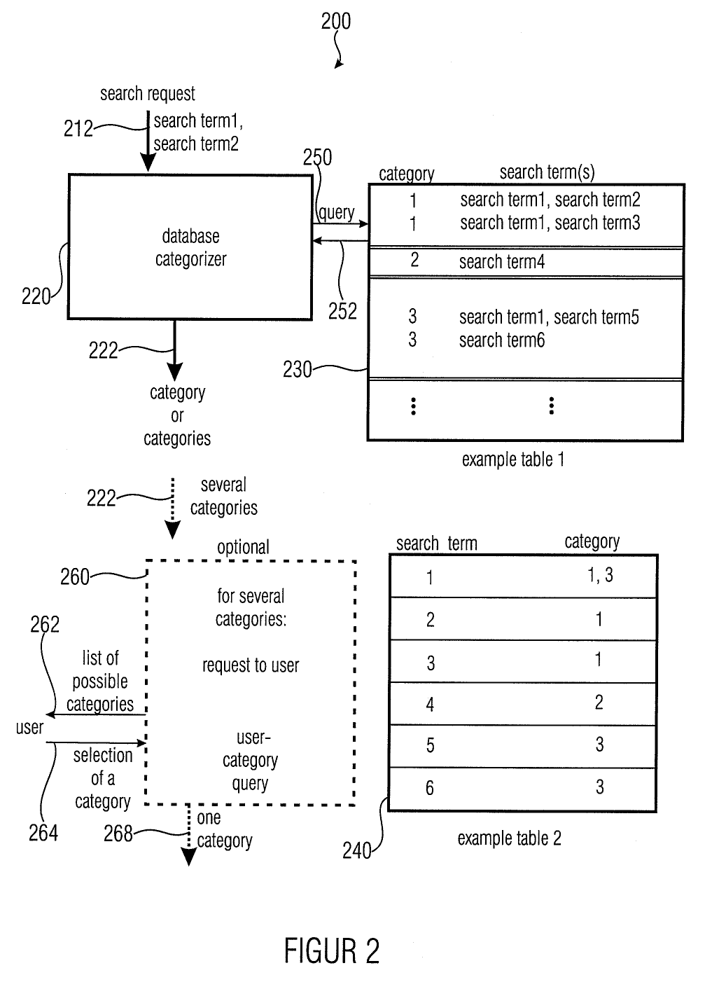

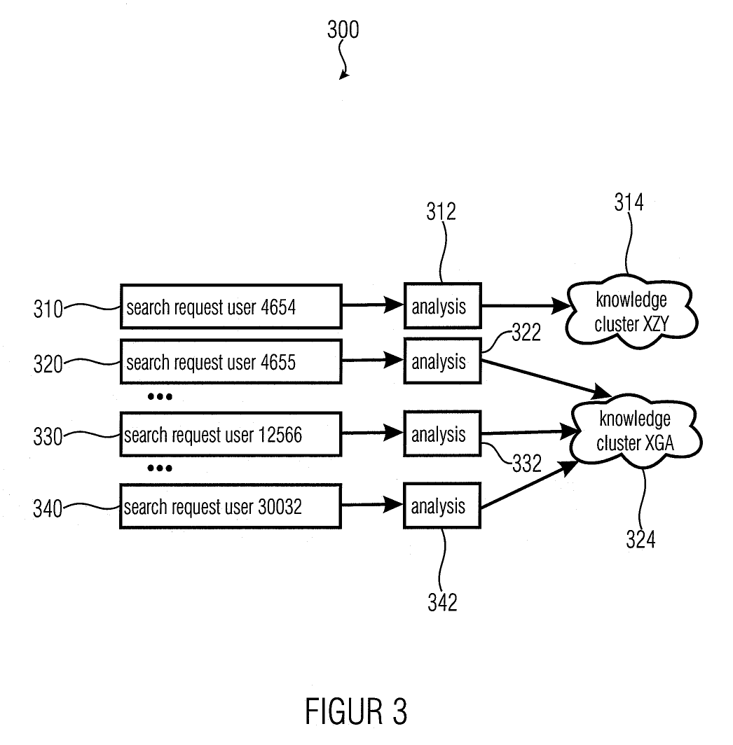

It is to be noted here that, in the following, it is assumed that the categorizer associates the search request with “category 1”. Besides, it is to be noted that the function of the categorizer is, for example, explained in more detail with respect to FIGS. 2 and 3.

The categorizer 120 thus provides at least information 122 on the category associated with the search request 112, 112′, so that an association between the user making the search request 112, 112′ (for example USER 1) and the category of the search request 112, 112′ is possible. A communication partner determiner 130 receives the information 122 on the category of the search request 112, 112′ and is further designed to find a second user (also referred to as USER 2 in the following) that has made a search request associated with the same category. For this purpose, the communication partner determiner may, for example, interrogate a database containing an association between the various known categories and user identifiers of users having made search requests of the corresponding category. One example of a data table of such a database and/or database table is designated 140. Further details with respect to the database table 140 will be described in more detail below.

However, it is essential that the communication partner determiner 130 identifies at least one other user, for example the second user USER 2, that has performed a search query of the same category, for example “category 1”, as the first user USER 1, whose search request is currently processed by the communication partner determiner 130. The communication partner determiner 130 thus provides information 132 indicating, for example, either which users have made a search request of the category described by the information 122 or at least information 132 indicating which further users have made a search request of the category described by the information 122 in addition to the first user USER 1 whose search request is currently processed. The information, 132 may indicate that only the first user USER 1 has made a search request of the category described by the information 122, that in addition to the first user USER 1, a further user (for example the second user USER 2) has made a search request of the corresponding category (category 1), or that a plurality of further users have made search requests of the above category in addition to the first user USER 1. The following exemplarily assumes that the information 132 indicates that both the first user USER 1 and the second user USER 2 have made a search request of the category described by information 122 (category 1).

An information supplier 150 thus receives the information 132 and is designed to provide information to the first user USER 1 and/or to the second user USER 2 based on the information 132. In one embodiment, the information supplier 150 is designed to provide information 152 to the first user USER 1 indicating to the first user USER 1 that there is a second user, i.e. the second user USER 2, that has made a search request of the same category (category 1) as the first user USER 1. Alternatively or additionally, the information supplier 150 may be designed to provide information to the second user USER 2 indicating to the second user USER 2 that the first user USER 1 has made a search request concerning the category designated by the information 122 (for example category 1).

Here, it is sufficient at first that the information supplier 150 provides the first user USER1 with the information 152 that there is a further user (for example the second user USER 2) that has made a search request of the category designated by the information 122. Similarly, it is sufficient that the information supplier 150 indicates to the second user USER 2 by the information 154 that there is a further user (for example the first user USER 1) that has made a search request concerning the above category.

However, it is preferred that the information 152 gives an indication to the first user USER 1 that (and additionally on which path, if applicable) the first user USER 1 has the possibility to set up a communication connection with the second user USER 2. Similarly, it is preferred that the information 154 gives an indication to the second user USER 2 that he/she has the possibility to enter into communication with the first user USER 1 via a communication connection.

Furthermore, it is preferred that the information 152 includes anonymized or non-anonymized information on the second user USER 2 allowing the first user USER 1 to establish a communication connection with the second user USER 2. Analogously, it is preferred that the information 154 includes anonymized or non-anonymized information on the first user USER 1 allowing the second user USER 2 to establish a communication connection with the first user USER 1.

The inventive device 100 thus allows two users (for example the first user USER 1 and the second user USER 2), both having made search requests of the same category (for example category 1), to enter into contact with each other. As soon as, for example, the first user USER 1 has been informed of the fact that there is a second user USER 2 that has made a search request of the same category by the information 152, the first user USER 1 may initiate a setup of a communication connection with the second user USER 2. The setup of the communication connection may be supported by the inventive device 100, the device 100, for example, providing information directly to the first user USER 1 with the information supplier 152, which he/she may use to identify the second user USER 2. For this purpose, the information 152 may preferably contain an anonymized or non-anonymized identification of the second user USER 2. Alternatively, the information 152 may also contain only information allowing the device 100 to set up a communication connection between the first user USER 1 and the second user USER 2, if the first user USER 1 wants this.

Alternatively or additionally, the second user USER 2 may possibly obtain information 152 essentially corresponding to the information 152, but containing the information and/or identifiers required for establishing contact with first user USER 1.

The following will discuss the construction and the use of the database table 140, by the interrogation of which the communication partner determiner 130 may determine users that have made one or more search requests of the category designated by the information 122. For this purpose, the database table 140 includes, for example, a first database column 162 describing the categories from the plurality of various categories. A second database column 164 of the database table 140 identifies various users of the device 100, for example by an anonymized or non-anonymized user identifier (for example USER 1, USER 2, USER 3, USER 4, USER 5). Generally, the database table 140 represents an association between various users of the device 100 and associated categories for which the users have made search requests. In other words, the database table 140 generally describes which users of the device 100 have made search requests concerning which category or which categories. In addition, it is to be noted that the communication partner determiner 130 does not necessarily have to access a database table 140, but only generally analyzes a database allowing it to determine those users of the device 100 that have made search requests concerning the category identified by the information 122. The communication partner determiner 130 thus provides a query 170 describing the category of the query 112, 112′ provided by the categorizer 120 to the corresponding database (represented by the database table 140). The corresponding database then provides a query response 172 to the communication partner determiner 130, wherein the query response 172 describes those users of the device 100 that have made search requests concerning the category provided by the categorizer 120, for example by user identifiers.

Besides, the database and/or the database table 140 may be updated corresponding to the information 122 provided by the categorizer 120. In other words, if the categorizer 120 reports that an i^{th} user USER i has made a search request of category j, an entry is added to the database and/or database table 140 reflecting the above fact.

Besides, it is to be noted that, in the database and/or database table 140, no user, one user or several users having made search requests of the given category may be associated with a given category. Besides, the database and/or database table 140 may show the fact that a user has made search requests of various categories. Alternatively, however, the database may also only contain the last search request of a user, so that, for example, a maximum of one category of a search request is associated with each user. Furthermore, the database and/or database table 140 may contain time information indicating when a given user has made the search request of a given category. The database management (not shown here) may, for example, be designed to delete all those entries of the database and/or database table 140 that are too far back in time (i.e. longer than a predetermined time duration).

Alternatively, the communication partner determiner 130 may be designed to take into account only such entries of the query response 172 that were more recent than a predetermined maximum time interval. Such a mechanism may ensure that old and/or too old information is not used and/or that the communication between two users is initiated only if the two users have made a search request of the same category within a sufficiently short time interval.

FIG. 2 shows a block circuit diagram of a categorizer for the use in an inventive device 100 according to FIG. 1.

The categorizer according to FIG. 2 is designated 200 in its entirety and may, for example, replace the categorizer 120 of device 100.

The categorizer 200 receives a search request 212 which, for example, consists of one or more search terms (for example two search terms search term 1, search term 2). However, the search request may alternatively also include multimedia information, such as already described above. For example, the categorizer includes a database categorizer 220 designed to determine a category of the search request 212 by interrogation of a database. As result, the database categorizer 220 provides information 222 describing one or more categories with which the search request 212 is associated.

It is to be noted here that the search request 212 may, for example, correspond to the search request 112 or the received search request 112′ of device 100 according to FIG. 1, and that the information 222 may correspond to the information 122 of device 100 according to FIG. 1. The database categorizer 222 is, for example, designed to make a query and/or request based on the search request 212 to a database represented by a first database table 230 and an alternative second database table 240. The request and/or database request is designated 250 and includes, for example, one or more of the search terms contained in the search request 212 and, if applicable and/or optionally, information on the logical combination (AND, OR, NOT, etc.) of the search terms.

The database table 230 shown by way of example describes an association between various categories of the plurality of various categories and associated search terms or logical combinations of search terms. For example, the database table 230 may define that the search request 212 is to be associated with the first category when both a first search term (search term 1) and a second search term (search term 2) are present in the search request 212. Furthermore, the database table may define, for example, that the search request 212 and/or the database query 250 is to be associated with the first category when both the first search term (search term 1) and a third search term (search term 3) are present in the database query 250. As a further example, the database table 230 may define that the database query 250 is to be associated with the second category when a fourth search term (search term 4) is contained in the database query. In other words, the database may, for example, define that a certain category is given when a certain search term or a logical combination of search terms is present in the database query 250. Thus, the database allows concluding the presence of one or more categories when one or more search terms are present in the database query 250. The query response 252 thus describes to which category or categories the database query 250 corresponds corresponding to the contents of the database. The information 222 thus describes the category or categories to which the search request 212 corresponds.

The database categorizer 220 may, for example, be designed to select a category best fitting the search request 212 from several categories provided by the database query response 252 according to a given rule. Alternatively, however, the database categorizer 220 may also be designed to describe several categories by the information 222.

If the information 222 includes several categories, the communication partner determination by the communication partner determiner 130 of device 100 according to FIG. 1 may be done several times in parallel or sequentially. In other words, for exemplary sequential processing, several categories are provided to the communication partner determiner 130 as information 122 one after the other, the determiner, in turn, generating information 132 several times describing one or more communication partners.

Thus, the information supplier 150 may provide several pieces of information 152 to the user generating the search request 112 (for example USER 1). Furthermore, the information supplier 150 may provide, in this case, alternatively or additionally, information 154 to several further users.

In a further preferred embodiment, the categorizer 200 optionally includes a user-category interrogator 260. The user-category interrogator 260 receives the information 222. If the information 222 describes several categories, the user-category interrogator 260 outputs a list 262 of the several categories described by the information 222 to the user making the search request 212. In this case, the user-category interrogator 260 receives a selection 264 of a category from the list 262 of possible categories from the above user. The selection 264 may alternatively also include a plurality of categories from the list 262 of possible categories. If the selection 264, however, includes only one category, the user-category interrogator 260 provides information 268 describing exactly one category. The information 268 may substitute the information 122 of device 100 according to FIG. 1.

Thus, by using the user-category interrogator 260, an optimum category of the search request 212 may be determined in a two-stage process. The database categorizer, for example, makes a preselection of a category based on a database query 250, while the user-category interrogator allows a final selection of the category with the cooperation of the user making the search request. The user is thus only confronted with a limited list 262 of possible categories typically representing only a subset of the total available categories. Thus, it is made easier for the user to provide a selection 262 of an optimum category.

However, it is to be stressed that the categorizer 200 represents only a possible example of a categorizer, that, however, other categorizers may also be used that associate information 222 and/or 268 on a category with a search request 212. Furthermore, it is to be noted that the use of the user-category interrogator 260 is optional.

FIG. 3 shows a schematic representation of a formation of common knowledge clusters by an analysis of search requests. The graphical representation of FIG. 3 is designated 300 in its entirety. The graphical representation 300 of FIG. 3 shows how various search requests of various users are associated with various categories and/or knowledge clusters. An analysis of a search request 310 of a user with the user identification 4654 shows, for example, that the search request 310 is associated with a knowledge cluster XZY. The knowledge cluster XZY is also designated 314 and describes a topic and/or a category associated, for example, with the search request 310 based on an analysis 312. The analysis 312 may, for example, be done by an evaluation of the search request 310 in the way shown in FIG. 2.

A search request 320 of a user with the user identification 4655 is further subjected to an analysis 322. The analysis 322 indicates that the search request 320 of the user with the user identification 4655 is to be associated with a knowledge cluster XGA (324). Similarly, a search request 330 of a user with the user identification 12566 is associated with the knowledge cluster XGA (324), which is determined by the analysis 332. A search request 340 of a user with the user identification 30032 is also associated with the knowledge cluster XGA (324). In other words, the search requests of the three users with the user identifications 4655, 12566 and 30032 are associated with the knowledge cluster XGA (324). In other words, the users with the user identifications 4655, 12566 and 30032, whose search requests are associated with the knowledge cluster XGA (324), are regarded as knowledge carriers with respect to the knowledge cluster XGA. In other words, the above three users are associated with the knowledge cluster XGA and/or a category corresponding with the knowledge cluster XGA. Thus, it is preferred that, for example, there is a 1:1 association between a knowledge cluster and a category. The corresponding information, i.e. the association of the users with knowledge clusters, may, for example, be deposited in the database represented by the database table 140.

Besides, the analyses 312, 322, 332, 342 of the search requests 310, 320, 330, 340 correspond to the categorization by the categorizer 220, 200. Besides, the association of the search requests 310, 320, 330, 340 with the knowledge clusters 314, 324 corresponds to the information 122, 222, 268 provided by the categorizer 120, 200.

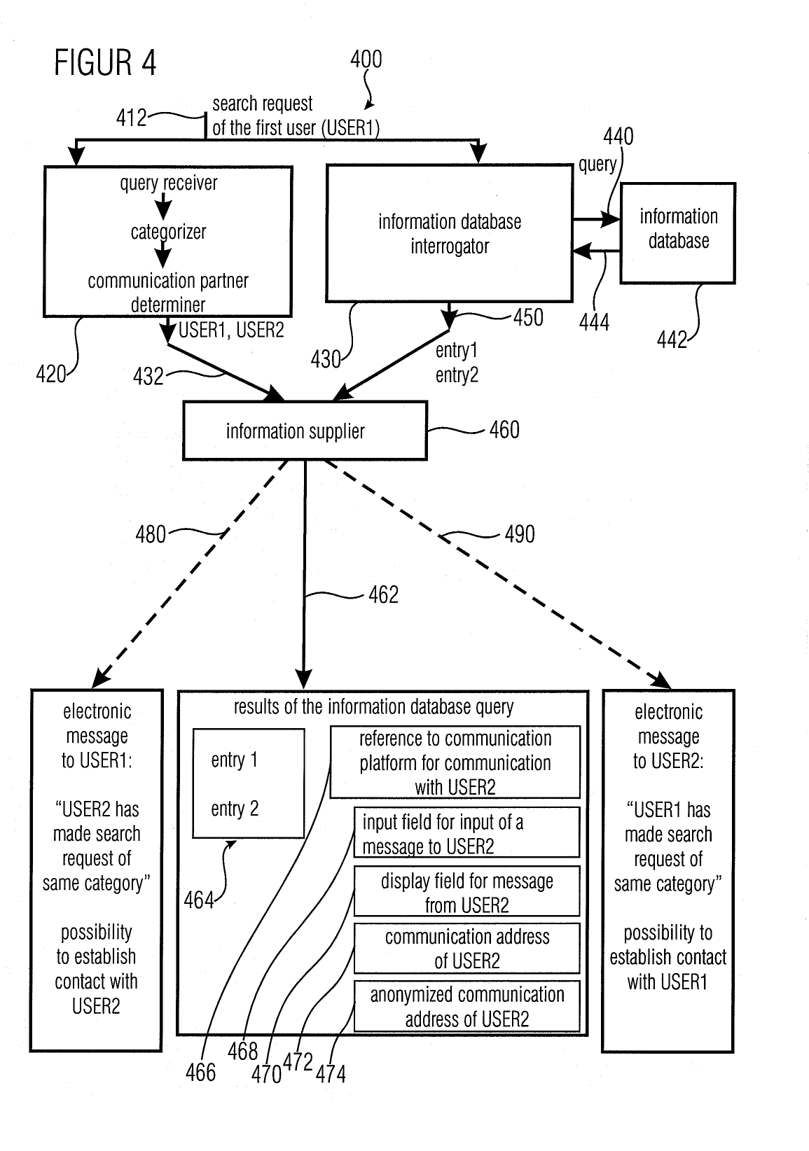

FIG. 4 shows a block circuit diagram of an inventive device for processing a search request according to a second embodiment of the present invention. The device of FIG. 4 is designated 400 in its entirety. The block circuit diagram 400 describes an inventive device allowing extended processing of a search request by both evaluating information on another user having made a search request of the same category and further also supplying the search request to an information database. The device 400 receives a search request 412 of a first user (USER 1) corresponding to the search requests 112, 112′ or 212 according to FIG. 1 or 2. The search request 412 is supplied both to a search request-user associator 420 and to an information database interrogator 430. The search request-user associator 420 essentially corresponds to the query receiver 110, the categorizer 120 and the communication partner determiner 130 of device 100 according to FIG. 1 and thus provides information 432 indicating which users have made a search request whose category is identical to a category associated with the search request 412. For example, the information 432 describes a first user USER 1 and a second user USER 2, analogously to the example according to FIG. 1.

Just like the search request-user associator 420, the information database interrogator 430 receives the search request 412 and generates a query 440 to an information database 442. The information database 442 includes, for example, a link between search terms and information sources. For example, the information database may include a catalog of internet addresses containing relevant information associated with a search term of the data query 440. Similarly, the information database 442 may also directly contain, for example, text information or multimedia information associated with a search term of the database query 440. A query response 444 generated as a response to the database query 440 of the information database 442 thus includes, for example, internet addresses, text documents, multimedia documents or the contents of internet addresses, text documents or multimedia documents. The information database interrogator 430 thus makes the contents of the database query response 444 available as information 450, possibly in processed form. The information 450 may thus, for example, represent a list of entries of the information database 442, as it is exemplarily shown in FIG. 4.

An information supplier 460 receives both the information 432 and the information 450. Besides, the information supplier 460 is designed to combine the information 432, 450 with each other, for example to generate an electronic description 462 of the combined information 432, 450. The information supplier 460 may, for example, be designed to provide the description 4.62 in any content description language, such as HTML, SHTML, UML, WML or another known content description language allowing a description of electronic contents. It is preferred that the description 462 also includes information regarding optical formatting, but this is not necessary.

The description 462 includes, for example, as illustrated in the graphical representation of FIG. 4, results of the information database query 440 and/or a representation 464 of the information 450. The description 462 further includes a representation of the information 432 summarized in a document or a group of documents belonging together connected by at least one cross-reference. In other words, both the information 432 and the information 450 are contained in a document or a group of connected and/or linked documents.

There are several possibilities for the representation of the information 432 that may be used together or alternatively and that are described in the following.

For example, the description 462 may include a reference 466 to a communication platform for communication with a user that has made a search request of the same category. The reference may, for example, give an electronic address at which the communication platform may be accessed. The reference 466 may further include an authorization identifier allowing the receiver of the description 462 to access the communication platform. Furthermore, the reference 466 may be designed to cooperate with executable program code (for example a script). The communication platform may, for example, be a text-based chat room, an audio chat room or an audiovisual chat room, but also an electronic discussion forum.

The description 462 may further include a description of an input field 468 allowing the first user to input a message for passing it to the second user. The input field 468 may further have a functionality to send the input message immediately or upon a prompt of the first user to the second user. Alternatively, the input field 468 may be designed to send the input message to the second user USER 2 with the help of an interposed server. The input field 468 may additionally be designed for cooperating with an executable program code controlling a process of a communication with the second user directly or via an interposed server. For the purposes of communication with the second user, the input field 468 or the executable program code linked with the input field may, for example, include a communication address of the second user or a user identifier of the second user.

Furthermore, the description 462 may include a description of a display field 470 (and/or of the contents displayed in the display field), so that the display field 470 is designed and/or driven to represent a message sent and/or transmitted by the second user USER 2, possibly with an interposed server, for the first user USER 1. The description 462 may also contain commands and/or executable instructions for the display field 470 allowing and/or supporting reproduction of the message sent by the second user USER 2 in the display field 470.

The description 462 may further include the description of a communication address 472 of the second user USER 2, which the information supplier 460 may, for example, derive from a database knowing the information 432. Alternatively, the description 462 may also contain an anonymized communication address 474 of the second user USER 2, which the information supplier 460 again adds to the description 462 based on the information 432.

The information supplier 460 may further send an electronic message 480 to the first user USER 1 based on the information 432 and possibly additional information from a database, the message indicating to the first user USER 1 that the second user USER 2 has made a search request of the same category as the first user USER 1. The corresponding electronic message may further contain an indication of a possibility to establish contact between the first user USER 1 and the second user USER 2. For example, the electronic message 480 may include a communication address of the second user USER 2 or an anonymized communication address of the second user USER 2.

Alternatively or additionally, the information supplier 460 may further be designed to send an electronic message 490 to the second user USER 2 in an analogous way using the information 432 and possibly additional information from a database, the message informing the second user USER 2 that the first user USER 1 has made a search request of the same category as the second user USER 2. The electronic message 490 may further point out a possibility of establishing contact with the first user USER 1 to the second user USER 2 and may optionally contain, for example, a communication address of the first user USER 1 or an anonymized communication address of the first user USER 1.

It is to be noted here that the generation of the electronic messages 480, 490 and the description 462 may be done alternatively or together. In other words, there may either be generated only the description 462, only the electronic message 480 or only the electronic message 490 by the information supplier 460, or any combination of the electronic messages 480, 490 and the description 462 may be generated.

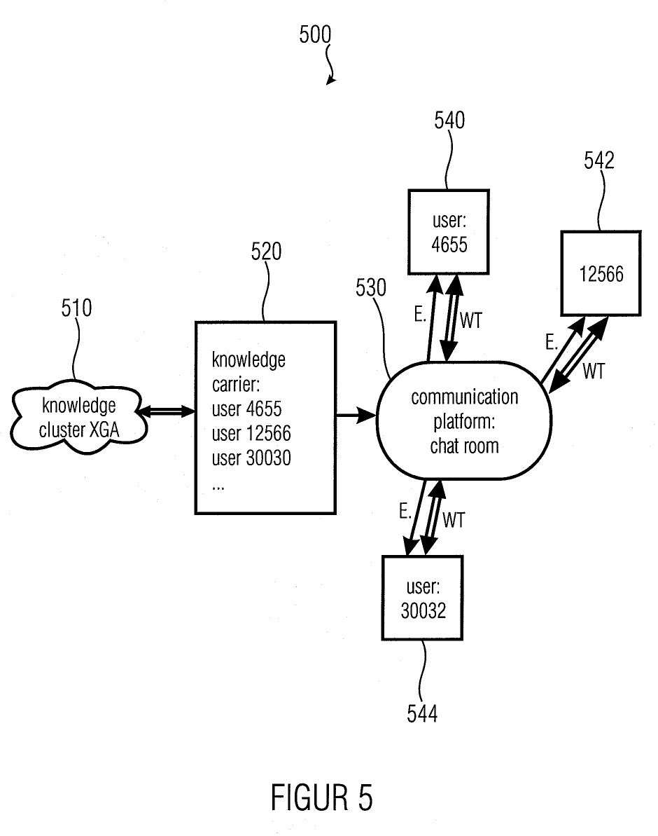

FIG. 5 shows a schematic representation of a process for an invitation (E) of chat participants from a field of knowledge and a knowledge transfer (WT) of participants and/or all participants via a communication platform. The graphical representation of FIG. 5 is designated 500 in its entirety.

The graphical representation 500 shows a plurality of knowledge carriers associated with a knowledge cluster XGA (510). The knowledge cluster XGA (510) may correspond to the knowledge cluster XGA (324) according to the graphical representation 300 of FIG. 3. A group 520 of knowledge carriers is associated with the knowledge cluster XGA (510). The group 520 includes, for example, users with the user identifications 4655, 12566 and 30032. In other words, the group 520 includes several users (3 in the given example), wherein an analysis of associated search requests (for example search requests 320, 330, 340) has determined that the corresponding users have made search requests 320, 330, 340 related to the knowledge cluster XGA (510) constituting a category of search requests. In other words, the users of the group 520 of users constitute knowledge carriers with respect to the knowledge cluster XGA (510).

In response to the detection that the group 520 includes more than one user, i.e. that more than one user has made search requests associated with the knowledge cluster XGA (510) constituting a category, for example within a predetermined time interval, the inventive device opens a communication platform 530. When opening the communication platform 530, which may, for example, be formed by a chat room and/or discussion room, the inventive device sends invitations E to the users of the group 520, i.e. for example to the users with the user identifications 4655, 12566 and 30032.

Among the above users also designated 540, 542 and 544, there is then a knowledge transfer designated WT using the communication platform 530 and/or the chat room 530.

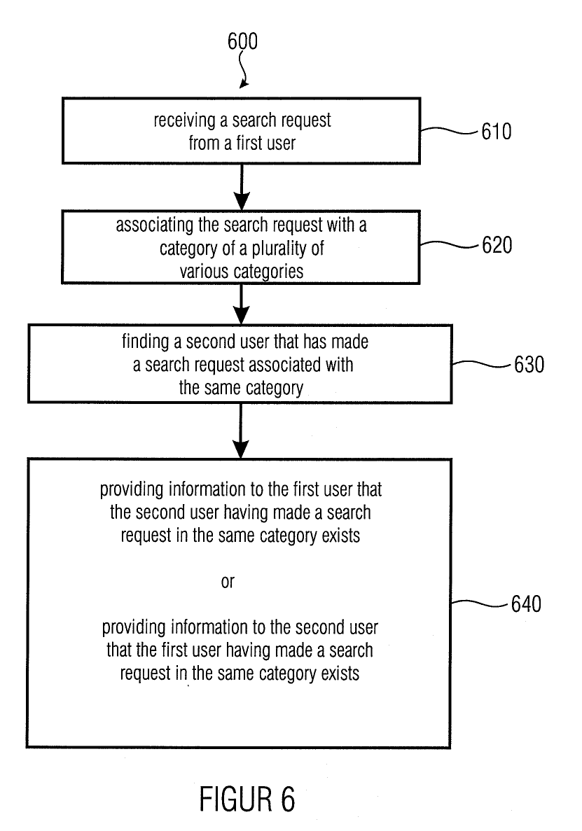

FIG. 6 shows a flow diagram of an inventive method according to an embodiment of the present invention. The inventive method is designated 600 in its entirety. In a first step 610, the method 600 includes receiving a search request from a first user. The method 600 further includes, in a second step 620, associating the search request with a category of a plurality of various categories. A third step 630 includes finding a second user that has made a search request associated with the same category as the search request of the first user. A fourth step 640 further includes supplying information to the first user that the second user having made a search request in the same category exists, and/or supplying information to the second user that the first user having made a search request of the same category exists.

The method 600 according to FIG. 6 may further be extended by all those steps described with respect to the inventive devices 100, 200, 400 and/or with respect to FIG. 3 or 5.

Summarizing, it may be said that it is an essential idea of the present invention to bring together people with the same field of interest or knowledge (also referred to as category of a search request) based on an analysis of their search requests in a search engine. In other words, the present invention allows communication between people and/or users whose search requests are associated with the same category.

Knowledge that is currently not registered in a search engine or is hard to find may thus be made accessible to the users by a knowledge exchange of knowledge carriers, for example a communication in the form of a chat and/or an electronic chat and/or an electronic discussion. In other words, the present invention allows knowledge exchange of knowledge carriers and/or users, whereby also such knowledge is made accessible to all users that is not available to a conventional electronic search engine and/or using a conventional electronic search engine, because it does not exist, for example, in electronically accessible form, but only as knowledge of the human users that is not directly obtainable electronically.

As part of the present invention, it has been found that an analysis of search requests of the users of a search engine may often allow to conclude a particular field of interest or knowledge of the requesting parties. Depending on the user, this may range from “no knowledge” to “partial knowledge” to relatively “comprehensive knowledge” in a certain topic.

When different users have a certain level of knowledge in a topic, it may be assumed that it is often not congruent in all aspects with the knowledge of others in this topic. This fact may be used to collect more knowledge on the respective topic together by communication and/or knowledge exchange of the users and/or knowledge carriers than each user would have on his/her own. In addition to the fact that it is possible to obtain knowledge from other users in a simple way, it is also conceivable that, by communication with other users, knowledge is generated that is not yet present in a search index of the search engine and that may only be made available to a user by this process. In other words, it is possible, for example, to generate knowledge by the communication of several users that is not yet included, for example, in the search index and/or, for example, in the information database 442 of the search engine (for example the information database interrogator 430).

In a preferred embodiment of the present invention, information generated during a communication of the users among each other may thus be added to the information database 442. For this purpose, the device 400 may, for example, give the users the possibility, using a user interface, to add new knowledge to the information database 442, for example by inputting entries into an input field. Furthermore, the information database 442 may alternatively add the whole information exchange, for example between the first user and the second user, to the information database 442. When adding, the information database 442 and/or an associated database controller may further extract search terms from the communication of the first user with the second user and thus allow access to the knowledge based on an information database query 440.

If, by appropriate analysis of the search requests of the users of the search engine, a linking of the users is established via common fields of knowledge or topics that may be determined by associating the search requests with categories, and the users are further given the possibility of knowledge exchange via the common communication platform (for example a text chat or an AV chat and/or audiovisual chat), the users may obtain more knowledge or information and/or obtain it more easily in this way than via the classic search functionality of a search engine.

In other words, the present invention thus represents a solution for the problem and/or the task that obtaining knowledge or information with a conventional search engine often involves a lot of effort and/or is time-consuming and does not have the desired result. Some information is not available at all with the conventional search engine even after an intensive and/or long search in a search index.

The present invention thus offers a solution for the above problem by performing a linking of the context of search requests of various users of a search engine to provide a common audiovisual chat (AV chat) or a text chat for knowledge exchange. Under certain circumstances, this allows a quicker and/or easier access to knowledge, because a question may be directed to a human person. Furthermore, the above concept partially also allows access to knowledge presently not registered in the search index, which, however, may be known to other users of the search engine.

In an embodiment of the present invention, the search requests arriving at a search engine are analyzed according to certain systematic criteria to be able to establish connections between the searched terms with respect to their association with a certain field of knowledge (“knowledge cluster”). In other words, an association with a certain field of knowledge is expressed by the fact that a search request is associated with a certain category and/or is associated therewith by the categorizer. If, for example, search requests may unambiguously be associated with a field of knowledge, an anonymous user identification is, for example, deposited in this field of knowledge, such as it can be seen from FIG. 3. In other words, if it is found that a search request of a given user may unambiguously be associated with a category, a (anonymous or non-anonymous) user identification of the particular user is stored in a database such that an association between the particular user and the corresponding category is possible. Details of the above functionality have been described, for example, with respect to an update of the database table 140 in connection with the device 100 according to FIG. 1.

Fields of knowledge and/or categories may both be predefined and be defined dynamically from the search criteria of the users (i.e. during runtime). In other words, if the search request may not be associated with any category present in a database and/or database table 140, the inventive device may generate a new category based on the search request (i.e. during runtime), for example a database update, including an association between a category and associated search terms (for example described with respect to database tables 230, 240).

As soon as a field of knowledge (and/or a category) already has a knowledge carrier (i.e. a user that has made a search request in the category), indicated by the fact that a user identification is entered for the field of knowledge and/or the category, a communication platform (for example in the form of a chat room) may be established between the users by a server and/or by the inventive device when there is another search request relevant for this field of knowledge. The users (i.e. for example those users that have made search requests associated with the same category) are, for example, suitably informed about the state (i.e. about the setup of a communication platform and/or a chat room). Thus, for information purposes, there will be, for example, a message in a browser in which the results of the search request are output. In other words, the inventive device is designed to provide information to an information viewing program (and/or a browser) of a user resulting in the information viewing program outputting a message that a communication platform for a field of knowledge (and/or for a category of a search request) exists or has been opened.

This message and/or “invitation” at the same time represents an authorized access possibility to the communication platform. In other words, the viewing program and/or the browser may obtain and display a reference and/or link from the inventive device allowing a user to log in at the communication platform. The reference and/or link may contain authorization information, wherefrom the communication platform may determine, by checking the authorization information, that a user attempting to log in at the communication platform is authorized.

All users thus accepting the above “invitation” may now use the communication platform and discuss the respective field of knowledge with others.

The following will describe an example of the inventive concept for processing a search request. By way of example, it is assumed that a user A (representing the first user and/or USER 1) is looking for the answer to a question how he/she may activate a spell check in word processing and/or a word processing program. Therefore, the user A inputs, for example, the terms “Microsoft and spell check” into the search engine and thus defines, for example, a search request. The search engine analyzes the search request and associates it, for example, with a field of knowledge “word processing: Microsoft Word”. A user B, i.e. a second user and/or USER 2, is for example looking for an answer to the question how he/she may italicize the characters in his/her word processor. Therefore he/she inputs, for example, the terms “Word and italics” into the search engine. In that way, the user B defines, for example, a search request. The search engine thus analyzes the search request and associates it with the field of knowledge “word processing: Microsoft Word”.

As both users have input their request and/or their search requests shortly one after the other (i.e. within a predetermined time interval), they are registered as “simultaneously online” (for example by the search engine and/or by the inventive device). Thereupon, both are, for example, immediately (or also with a time delay) signaled an invitation for a knowledge exchange on a (existing or newly established) communication platform.

It is further assumed that both users accept the offer and/or the invitation for electronic communication via the communication platform, for example because they have not found any answer to their question on the first pages of the normal search results. In other words, the search engine provides, for example, not only the invitation for the electronic communication via the communication platform, but also further search results by forwarding the search request to a database providing associated information and/or references to information (i.e. for example references to websites containing a representation of information) based on the search request. Thus, the inventive device and/or search engine combines the search in a database with a classification of search requests of various users into categories and a provision of information allowing communication among users that have made search requests of the same category.

Therefore, if both users accept the offer for electronic communication with each other via the communication platform, the two users may pose their respective question and/or search request to the other participant and/or user of the communication platform. When posing the respective question to the other participant of the communication platform, both thus obtain, for example, an answer from their human communication partner immediately and without further complications.

It is to be noted here that the determination of a field of knowledge and/or topic of the search request corresponds to the association of the search request with a category described above, which is, for example, achievable with a database request, as described above.

The following once again summarizes the relevant properties of the inventive concept and/or the inventive device. A significant advantage of the inventive concept is that the inventive concept allows getting users and/or persons interested in the same topic into direct communication with each other. In other words, based on an analysis and/or categorization of the search requests of the at least two users, it may be determined whether the search requests of the at least two users are related to the same category and/or the same topic. If this is the case, the users are informed by an electronic message that there is another user that has made a search request of the same category and/or the same topic. Furthermore, at least one of the two users is provided with information enabling him/her to enter into direct electronic communication with the other user. This allows a user that has put a certain search request into the search engine not only to obtain a machine-generated search result, but further to be enabled to enter into communication with a human communication partner. With the help of a human communication partner, a question (and/or search request) is understood better (than with the help of an electronic system) in most cases and may thus be answered faster than with a classic search engine inquiry.

Furthermore, it is an advantage of the present invention that it may be realized anonymously, i.e. that a communication between the two users that have made search requests of the same category may take place without the users having to reveal their actual identity. The inventive device rather allows anonymization as, for example, the inventive device gives anonymized user identifiers to the users and maintains a database allowing a conversion of the anonymized user identifiers to actual user identifiers. The inventive device may then forward the communication from the first user to the second user, wherein, for example, the first user only knows the anonymized identification of the second user, and wherein the inventive device converts the anonymized user identifier of the second user to the actual user identifier of the second user and thus forwards a message sent by the first user using the anonymized user identifier to the second user using the actual user identifier of the second user.

In a further embodiment, the communication between the inventive device and the users may take place in an encrypted way. Alternatively, the communication among the various users may also take place in an encrypted way, while the communication between a user and the search engine and/or the inventive device may take place without encryption.

The communication between two users that have made search requests of the same category and/or concerning the same topic may take place, for example, as text chat and/or text discussion, audio chat and/or audio discussion and/or as AV chat and/or audiovisual discussion.

Furthermore, the inventive device may, under certain circumstances, integrate and/or include a charge-free expert. For example, the charge-free expert may be a user associated with one or more categories of search requests and available, for example, for the communication with users making search requests.

If the field of knowledge cannot be determined unambiguously by a search request, a selection of suitable fields of knowledge may optionally be suggested to the user. With respect to the above example, the user may be asked, for example: Is your question related to “operating system: Microsoft Windows” or “word processing: Microsoft Word”?

There may further take place an immediate meeting of the knowledge carriers, or the meeting of the knowledge carriers may take place offset in time. In other words, a user may, for example, indicate that he/she is also interested in a knowledge exchange with other knowledge carriers in this topic at a later point in time, if no other users are currently registered in this field of knowledge.

The user of the inventive device is thus given the advantage that a complicated search in the internet, where this problem might also be discussed, is eliminated. The inventive search engine may thus indirectly, via the knowledge of its users, provide information that is currently not present at all in its classic search index.

It is further to be noted that the inventive concept may be implemented both as a device and as a method. Furthermore, the inventive concept may be implemented by a computer program.

Depending on the circumstances, the inventive concept or method may be implemented in hardware or in software. The implementation may be done on a digital storage medium, for example a floppy disk, CD, DVD or a flash storage medium, in a ROM, PROM, EPROM or EEPROM with control signals that may be read out electronically, which may cooperate with a programmable computer system so that the corresponding method is executed. Generally, the invention thus also consists in a computer program product with program code stored on a machine-readable carrier for performing the inventive method, when the computer program product runs on a computer. In other words, the invention may be realized as a computer program with a program code for performing the method when the computer program runs on a computer.

Thus, it may finally be said that the inventive device provides the possibility of an efficient search and/or an efficient information exchange between various users by offering the possibility to the users, based on a categorization of search requests, to enter into electronic communication with other users that have made a search request of the same category.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for processing a search request, comprising:
a query receiver for receiving a search request from a first user;
a categorizer for associating the search request with a category of a plurality of various categories;
a communication partner determiner for finding a second user that has made a search request associated with the same category; and
an information supplier for supplying information to the first user that the second user having made a search request of the same category exists, or
for supplying information to the second user that the first user having made a search request of the same category exists.

2. The device of claim 1, wherein the information supplier is designed to supply information including a notification about a possibility to establish electronic communication with each other to the first user or the second user in response to detecting that the first user and the second user have made search requests associated with the same category.

3. The device of claim 1, further designed to provide a communication platform by which the first user and the second user may communicate with each other electronically, and
wherein the information supplier is designed to supply a message to the first user and/or the second user, the message being designed to allow an access to the communication platform or to authorize the first user and/or the second user for an access to the communication platform.

4. The device of claim 3, designed to provide an electronic chat room as the communication platform, via which the first user and the second user may communicate with each other, and
wherein the information supplier is designed to supply messages containing a reference to the electronic chat room to the first user and the second user.

5. The device of claim 4, wherein the information supplier is designed to supply authorization identifiers to the first user and the second user that authorize the first user and the second user for an access to the electronic chat room.

6. The device of claim 1, designed to provide the information on the fact that the second user having made a search request of the same category exists to the first user by providing a communication platform, or
to provide the information on the fact that the first user having made a search request of the same category exists to the second user by providing the communication platform.

7. The device of claim 1, wherein the information supplier is designed to provide the information that the second user having made a search request of the same category exists to the first user, the information supplier providing information on an electronic communication address of the second user to the first user, or
wherein the information supplier is designed to provide the information that the first user having made a search request of the same category exists to the second user, the information supplier providing information on an electronic communication address of the first user to the second user.

8. The device of claim 1, further including a message forwarder and an identification database, wherein the identification database is designed to store an association between anonymized electronic communication addresses and actual electronic communication addresses, and wherein the identification database includes an anonymized electronic communication address of the first user, an anonymized electronic communication address of the second user, an actual electronic communication address of the first user and an actual electronic communication address of the second user, and
wherein the message forwarder is designed to receive an electronic message with an anonymized electronic communication address as target address, to read out an actual electronic communication address associated with the anonymized electronic communication address from the identification database, and to forward the electronic message with the read-out actual electronic communication address, and
wherein the information supplier is designed to provide the anonymized electronic communication address of the second user to the first user, or to provide the anonymized electronic communication address of the first user to the second user.

9. The device of claim 1, wherein the communication partner determiner is designed to find out whether the request receiver has received the search requests of the first user and the second user within a predetermined time interval, and
wherein the information supplier is designed to provide the information only when the request receiver has received the search request of the first user and the search request of the second user associated with the same category within the predetermined time interval.

10. The device of claim 1, wherein the communication partner determiner is designed to determine whether the second user is available for communication, and
wherein the information supplier is designed to provide the information only when the communication partner determiner indicates that the second user is available for communication.

11. The device of claim 10, wherein the communication partner determiner is designed to indicate that the second user is available for communication, if the second user has made a search request within a predetermined interval.

12. The device of claim 1, further comprising an information database with a plurality of entries related to various possible search requests, and further comprising an information database interrogator designed to search the information database for entries related to the search request of the first user, and
wherein the information supplier is designed to provide information to the first user based on at least one entry of the information database related to the search request of the first user in addition to the information that the second user having made the search request of the same category exists.

13. The device of claim 1, wherein the categorizer is designed to associate the search request with at least one category based on one or more words contained in the search request.

14. The device of claim 13, wherein the categorizer is designed to output a list of categories with which the search request is associable to a user,
to read in a decision from the user with which category from the list of categories the search request is to be associated, and
to associate the search request with a category based on the decision.

15. The device of claim 1, wherein the communication partner determiner is designed to output a query to a particular user whether the particular user wants a later establishment of contact with a further user that will make a search request of the same category in the future, if the communication partner determiner finds out that currently no further user having made a search request of the same category exists or is available for communication, and
wherein the communication partner determiner is further designed to enter or not to enter the particular user into a database available to the communication partner determiner for finding users that have made search requests of the same category, depending on an answer read in from the user.

16. A method for processing a search request, comprising:
receiving a search request from a first user;
associating the search request with a category from a plurality of various categories;
finding a second user that has made a search request associated with the same category; and
providing information to the first user that the second user having made a search request of the same category exists, or
providing information to the second user that the first user having made a search request of the same category exists.

17. A computer program with a program code for performing the method for processing a search request, when the computer program runs on a computer, the method comprising receiving a search request from a first user; associating the search request with a category from a plurality of various categories; finding a second user that has made a search request associated with the same category; and providing information to the first user that the second user having made a search request of the same category exists, or providing information to the second user that the first user having made a search request of the same category exists.
